(19) United States
(12) Patent Application Publication
(10) Pub. No.: US 2026/0324640 A1
(43) Pub. Date: Oct. 22, 2026

(54) HERBICIDE COMBINATIONS WITH SAFENER

(71) Applicants: UPL Mauritius Limited, Port Louis (MU); UPL Europe Supply Chain Gmbh, Rotkreuz/Risch (CH)

(72) Inventor: Fernando César CABONA, Buenos Aires (AR)

(21) Appl. No.: 19/122,015

(22) PCT Filed: Oct. 18, 2023
(86) PCT No.: PCT/EP2023/079016

§ 371 Date: Apr. 17, 2025

(30) Foreign Application Priority Data
Oct. 18, 2022 (IN) 202221059582

(51) Int. Cl. A01N 43/707; A01N 25/32; A01N 43/40; A01N 43/653; A01P 13/00

(52) U.S. Cl. CPC A01N 43/707; A01N 25/32; A01N 43/40; A01N 43/653; A01P 13/00

(57) ABSTRACT

The present disclosure relates to combinations for the selective control of weeds. More particularly, the present disclosure relates to combination of herbicides, especially clodinafop-propargyl, flucarbazone and metribuzin, with safeners for the selective control of weeds.

### FIELD OF THE INVENTION

The present disclosure relates to combinations for the selective control of weeds. More particularly, the present disclosure relates to combination of herbicides with safeners for the selective control of weeds.

### BACKGROUND OF THE INVENTION

Some very effective herbicides i.e., herbicides that exhibit highly effective weed control exhibit toxicity on the crop itself along with weeds. In other words, they exhibit nonselective control of weeds to be eliminated. This is also the case with Acetyl COA carboxylase inhibitor herbicides, Acetolactate synthase inhibitor herbicides, and Photosynthesis II inhibitor herbicides that exhibit excellent weed control, but at the cost of damage to the crop itself. Sometimes this undesired effect on the crop can be so devastating that the whole crop gets wiped out. In such cases, phytotoxicity is said to be 100%. Other instances of unwanted effects of herbicides on crops are lesser plant height or lesser number of plants standing after herbicidal treatments.

Acetyl COA carboxylase inhibitor herbicides act by affecting membrane synthesis by inhibiting Acetyl COA carboxylase enzyme which is important in fatty acid synthesis. Acetyl COA carboxylase inhibitor herbicides have different chemistries such as Aryloxyphenoxypropionates, Cyclohexanediones and Phenyl pyrazoline.

Acetolactate synthase inhibitor herbicides act by affecting the biosynthesis of the branched-chain amino acids isoleucine, leucine, and valine by inhibiting enzyme Acetolactate synthase (ALS) also called as Acetohydroxy Acid Synthase (AHAS). Acetolactate synthase inhibitor herbicides have different chemistries such as Imidazolinones, Pyrimidinyl benzoates, Sulfonanilides, Sulfonylureas, Triazolinones and Triazolopyrimidine.

Photosynthesis II inhibitor herbicides act by affecting the electron transport and stops CO₂ fixation and production of energy needed for plant growth by inhibiting photosynthesis by binding to D1 proteins of the photosystem II complex in chloroplast thylakoid membranes. Photosynthesis II inhibitor herbicides have different chemistries such as Amides, Phenyl carbamates, Pyridazinone, Triazines, Triazinones, Uracils, and Ureas.

Chemical agents called as safeners, when used with herbicides, act as their antidotes and make use of the herbicides safer. However, it is pertinent to note that not all the safeners work well with all the herbicides. Scientists are always facing the challenge of finding safener-herbicide combinations that work well.

There is, therefore, a need in the art for combinations of herbicides comprising a combination of one or more Acetyl COA carboxylase inhibitor herbicides, Acetolactate synthase inhibitor herbicides, and Photosynthesis II inhibitor herbicides and one or more safeners that provide selective control.

### OBJECTIVES OF THE INVENTION

It is an objective of the present disclosure to provide combinations of herbicides with safeners.

It is an objective of the present disclosure to provide combinations of herbicides with safeners, wherein herbicides comprise a combination of one or more Acetyl CoA carboxylase inhibitor herbicides, Acetolactate synthase inhibitor herbicides, and Photosynthesis II inhibitor herbicides.

It is an objective of the present disclosure to provide combinations of herbicides with safeners, wherein herbicides comprise a combination of one or more Acetyl CoA carboxylase inhibitor herbicides, Acetolactate synthase inhibitor herbicides, and Photosynthesis II inhibitor herbicides and said combinations exhibit selective control.

It is an objective of the present disclosure to provide combinations of herbicides with safeners, wherein herbicides comprise a combination of one or more of Acetyl CoA carboxylase inhibitor herbicides, Acetolactate synthase inhibitor herbicides, and Photosynthesis II inhibitor herbicides and said combinations exhibit selective control, preferably in corn, wheat, barley, rye, oats, rice, soybean, cotton, canola, sugar beet, potatoes, tobacco, and oilseed rape, more preferably in soybean.

### SUMMARY OF THE INVENTION

In an aspect, present disclosure provides combinations of herbicides with safeners.

In an aspect, present disclosure provides combinations of herbicides with one or more safeners, wherein the herbicides comprise a combination of Acetyl COA carboxylase inhibitor herbicides, Acetolactate synthase inhibitor herbicides, and Photosynthesis II inhibitor herbicides.

In an aspect, present disclosure provides combinations of herbicides with one or more safeners, wherein herbicides comprise a combination of Acetyl COA carboxylase inhibitor herbicides, Acetolactate synthase inhibitor herbicides, and Photosynthesis II inhibitor herbicides and wherein safeners are selected from the group comprising Mefenpyr-diethyl, Isoxadifen-ethyl, Cloquintocet-mexyl, Dichlormid, Benoxacor, Flurazole and Fluxofenim.

In an aspect, present disclosure provides combinations of herbicides with one or more safeners, wherein herbicides comprise a combination of Acetyl COA carboxylase inhibitor herbicides, Acetolactate synthase inhibitor herbicides, and Photosynthesis II inhibitor herbicides and said combinations exhibit selective control, preferably in corn, wheat, barley, rye, oats, rice, soybean, cotton, canola, sugar beet, potatoes, tobacco, and oilseed rape, more preferably in soybean.

### DETAILED DESCRIPTION OF THE INVENTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10 or ±5 of the stated value.

The use of the terms “a” and “an” and “the” and similar referents (especially in the context of the following claims) are to be construed to cover both the singular and the plural, unless otherwise indicated herein or clearly contradicted by context. The terms first, second etc. as used herein are not meant to denote any particular ordering, but simply for convenience to denote a plurality of, for example, layers.

The terms “comprising”, “having”, “including”, and “containing” are to be construed as open-ended terms (i.e., meaning “including, but not limited to”) unless otherwise noted. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

As used herein, the term “control” relates to a weed, includes control of the weed, as well as protecting a plant, a portion of the plant, or a plant seed from attack or invasion by said weed.

As used herein, the term “agrochemical” refers to all active substances which can be used in the agrochemical field, i.e., fungicides, bactericides, insecticides, acaricides, nematicides, molluscicides, rodenticides, repellents, plant growth regulators, herbicides and safeners, and plant nutrients.

Subsequently, the term “herbicide” encompasses both herbicides as well as plant growth regulators, in so far as this does not otherwise emerge from the context. The term herbicide as used herein denotes a compound which controls or modifies the growth of undesired weeds/plants.

The term “herbicidally effective amount” indicates the quantity of such a compound or combination of such compounds which is capable of controlling or modifying effect on the growth of harmful plants/undesired vegetation/weeds. Controlling effects include all deviation from natural development, for example: killing, retardation, leaf burn, albinism, dwarfism, etc.

As used herein the term “plant” or “crop” refers to whole plants, plant organs (e.g., leaves, stems, twigs, roots, trunks, limbs, shoots, fruits etc.), plant cells, and plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolon, and buds and other parts of plants, including seedlings and young plants, which are to be transplanted after germination or after emergence from soil.

As used herein, the term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

As used herein, the term “seed” embraces seeds and plant propagules of all kinds including but not limited to true seeds, seed pieces, suckers, corms, bulbs, fruit, tubers, grains, cuttings, cut shoots and the like. In a preferred embodiment a seed is a true seed.

As used herein, the term “pre-emergence” refers to the time point before seedlings emerge from the ground. When any herbicide is applied at pre-emergence stage, it prevents establishment of the germinated weed seedlings.

As used herein, the term “post-emergence” refers to the time point after seedlings emerge from the ground. When any herbicide is applied at post-emergence stage, it prevents growth of the germinated weed seedlings.

As used herein, the term “increased yield” of an agricultural plant means that the yield of a product of the respective plant is increased by a measurable amount over the yield of the same product of the plant produced under the same conditions, but without the application of the compositions described herein. According to the present disclosure, it is preferred that the crop yield be increased by at least 0.5%, preferably at least 2%, more preferably at least 5%, upon application of the combinations and compositions described herein.

The term “weed” as used herein refers to the plant whose growth is considered undesirable in a particular situation i.e., growth of a plant at a wrong place and includes pesticide resistant plants. In the broadest sense, the term “weed” refers to plants which grow in locations in which they are not desired. In other words, a “weed” is a plant in which in the context of a crop is undesirable due to competition for water, nutrients, sunlight, soil, etc. The term may also refer to crop plants which are undesirable at a location. As used herein, the terms “undesirable vegetation”, “harmful plants”, “unwanted plants”, “weeds” and “weed species”, as used herein, are synonyms.

Typically, the combinations/compositions of the present disclosure are applied to the targeted weed or to their locus or to the crop/plant. The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus. The said locus could be a weed, an area adjacent to the weed, soil adapted to support growth of the weed, a root of the weed and/or foliage of the weed.

As used herein, the term “phytotoxicity” refers to any adverse effect or reaction on plant growth, physiology, or metabolism caused by any chemical substance, fertilizer, herbicide, heavy metal, etc.

While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

It has surprisingly been found by the present inventors that combinations of Acetyl CoA carboxylase inhibitor herbicides, Acetolactate synthase inhibitor herbicides, and Photosynthesis II inhibitor herbicides with safeners selectively control weeds.

In an embodiment, present disclosure provides combinations of herbicides with one or more safeners, wherein the herbicides comprise a combination of one or more Acetyl COA carboxylase inhibitor herbicides, Acetolactate synthase inhibitor herbicides, and Photosynthesis II inhibitor herbicides.

In an embodiment, the present disclosure provides a herbicidal combination comprising:
at least one Acetyl COA carboxylase inhibitor herbicide;
at least one acetolactate synthase inhibitor herbicide;
at least one photosynthesis II inhibitor herbicide; and
at least one safener.

In another embodiment, the safener is selected from the group comprising mefenpyr-diethyl, isoxadifen-ethyl, cloquintocet-mexyl, dichlormid, benoxacor, flurazole, fluxofenim, or combinations thereof.

In an embodiment, present disclosure provides combinations of herbicides with one or more safeners, wherein herbicides comprise a combination of Acetyl COA carboxylase inhibitor herbicides, Acetolactate synthase inhibitor herbicides, and Photosynthesis II inhibitor herbicides and wherein safeners are selected from the group comprising Mefenpyr-diethyl, Isoxadifen-ethyl, Cloquintocet-mexyl, Dichlormid, Benoxacor, Flurazole and Fluxofenim.

In an embodiment, present disclosure provides combinations of herbicides with one or more safeners, wherein herbicides comprise a combination of Acetyl COA carboxylase inhibitor herbicides, Acetolactate synthase inhibitor herbicides, and Photosynthesis II inhibitor herbicides and said combinations exhibit selective control, preferably in corn, wheat, barley, rye, oats, rice, soybean, cotton, canola, sugar beet, potatoes, tobacco, and oilseed rape, more preferably in soybean.

In a preferred embodiment, the Acetyl COA carboxylase inhibitor herbicide is Clodinafop-propargyl.

In a preferred embodiment, the Acetolactate synthase inhibitor herbicide is Flucarbazone.

In a preferred embodiment, the Photosynthesis II inhibitor herbicide is Metribuzin. In a preferred embodiment, the safener is Cloquintocet-mexyl.

In a preferred embodiment, the combination of Acetyl COA carboxylase inhibitor herbicides, Acetolactate synthase inhibitor herbicides, and Photosynthesis II inhibitor herbicides is a combination of Clodinafop-propargyl, Flucarbazone and Metribuzin.

In an embodiment, present disclosure provides a herbicidal combination comprising Clodinafop-propargyl, Flucarbazone, Metribuzin and Cloquintocet-mexyl.

In an embodiment, present disclosure provides a herbicidal combination comprising Clodinafop-propargyl, Flucarbazone, Metribuzin and Mefenpyr-diethyl.

In an embodiment, the present disclosure provides a herbicidal combination comprising Clodinafop-propargyl, Flucarbazone, Metribuzin and Isoxadifen-ethyl.

In an embodiment, the present disclosure provides a herbicidal combination comprising Clodinafop-propargyl, Flucarbazone, Metribuzin and Dichlormid.

In an embodiment, the present disclosure provides a herbicidal combination comprising Clodinafop-propargyl, Flucarbazone, Metribuzin and Benoxacor.

In an embodiment, the present disclosure provides a herbicidal combination comprising Clodinafop-propargyl, Flucarbazone, Metribuzin and Flurazole.

In an embodiment, the present disclosure provides a herbicidal combination comprising Clodinafop-propargyl, Flucarbazone, Metribuzin and Fluxofenim.

In an embodiment, the present disclosure provides a herbicidal combination comprising Clodinafop-propargyl, Flucarbazone, Metribuzin and Cloquintocet-mexyl and said combination exhibits less or no phytotoxicity preferably in corn, wheat, barley, rye, oats, rice, soybean, cotton, canola, sugar beet, potatoes, tobacco, and oilseed rape.

In an embodiment, the present disclosure provides a herbicidal combination comprising Clodinafop-propargyl, Flucarbazone, Metribuzin and Mefenpyr-diethyl and said combination exhibits less or no phytotoxicity preferably in corn, wheat, barley, rye, oats, rice, soybean, cotton, canola, sugar beet, potatoes, tobacco, and oilseed rape.

In an embodiment, the present disclosure provides a herbicidal combination comprising Clodinafop-propargyl, Flucarbazone, Metribuzin and Isoxadifen-ethyl and said combination exhibits less or no phytotoxicity preferably in corn, wheat, barley, rye, oats, rice, soybean, cotton, canola, sugar beet, potatoes, tobacco, and oilseed rape.

In an embodiment, the present disclosure provides a herbicidal combination comprising Clodinafop-propargyl, Flucarbazone, Metribuzin and Dichlormid and said combination exhibits less or no phytotoxicity preferably in corn, wheat, barley, rye, oats, rice, soybean, cotton, canola, sugar beet, potatoes, tobacco, and oilseed rape.

In an embodiment, the present disclosure provides a herbicidal combination comprising Clodinafop-propargyl, Flucarbazone, Metribuzin and Benoxacor and said combination exhibits less or no phytotoxicity preferably in corn, wheat, barley, rye, oats, rice, soybean, cotton, canola, sugar beet, potatoes, tobacco, and oilseed rape.

In an embodiment, the present disclosure provides a herbicidal combination comprising Clodinafop-propargyl, Flucarbazone, Metribuzin and Flurazole and said combination exhibits less or no phytotoxicity preferably in corn, wheat, barley, rye, oats, rice, soybean, cotton, canola, sugar beet, potatoes, tobacco, and oilseed rape.

In an embodiment, the present disclosure provides a herbicidal combination comprising Clodinafop-propargyl, Flucarbazone, Metribuzin and Fluxofenim and said combination exhibits less or no phytotoxicity preferably in corn, wheat, barley, rye, oats, rice, soybean, cotton, canola, sugar beet, potatoes, tobacco, and oilseed rape.

In an embodiment, the Photosystem II Inhibitor herbicide is selected from one or more of below listed herbicides or their salts, esters, isomers, and combinations thereof as disclosed in Table 1.

TABLE 1
Photosystem II Inhibitor herbicides

| | Chemical Class | Photosystem II |
|---|---|---|
| | of Photosystem II | Inhibitor |
| Sr. No. | Inhibitor herbicide | herbicide |
| 1. | Amides | Chloranocryl = dicryl |
| 2. | | Pentanochlor |
| 3. | | Propanil |
| 4. | Phenylcarbamates | Chlorprocarb |
| 5. | | Desmedipham |
| 6. | | Phenisopham |
| 7. | | Phenmedipham |
| 8. | Pyridazinone | Brompyrazon |
| 9. | | Chloridazon |
| 10. | Triazines | Ametryne |
| 11. | | Atraton |
| 12. | | Atrazine |
| 13. | | Aziprotryne = aziprotryn |
| 14. | | CP 17029 |
| 15. | | Chlorazine |
| 16. | | Cyanazine |
| 17. | | Cyprazine |
| 18. | | Desmetryne |
| 19. | | Dimethametryn |
| 20. | | Dipropetryn |
| 21. | | Eglinazine-ethyl |
| 22. | | Ipazine |
| 23. | | Methoprotryne = methoprotryn |
| 24. | | Proglinazine-ethyl |
| 25. | | Prometon |
| 26. | | Prometryne |
| 27. | | Propazine |
| 28. | | Sebuthylazine |
| 29. | | Secbumeton |
| 30. | | Simazine |
| 31. | | Simetryne |
| 32. | | Terbumeton |
| 33. | | Terbuthylazine |
| 34. | | Terbutryne |
| 35. | | Trietazine |
| 36. | | Procyazine |
| 37. | Triazinones | Ethiozin |
| 38. | | Hexazinone |
| 39. | | Isomethiozin |
| 40. | | Metamitron |
| 41. | | Metribuzin |
| 42. | | Amicarbazone |
| 43. | Uracils | Bromacil |
| 44. | | Isocil |
| 45. | | Lenacil |
| 46. | | Terbacil |
| 47. | Ureas | Benzthiazuron |
| 48. | | Bromuron |
| 49. | | Buturon |
| 50. | | Chlorbromuron |
| 51. | | Chlorotoluron |
| 52. | | Chloroxuron |
| 53. | | Difenoxuron |
| 54. | | Dimefuron |
| 55. | | Diuron |
| 56. | | Ethidimuron |
| 57. | | Fenuron |
| 58. | | Fluometuron |
| 59. | | Fluothiuron |
| 60. | | Isoproturon |
| 61. | | Isouron |
| 62. | | Linuron |
| 63. | | Methabenzthiazuron |
| 64. | | Metobenzuron |
| 65. | | Metobromuron |
| 66. | | Metoxuron |
| 67. | | Monolinuron |
| 68. | | Monuron |
| 69. | | Neburon |
| 70. | | Parafluron |
| 71. | | Siduron |
| 72. | | Tebuthiuron |

In an embodiment, the acetyl COA carboxylase inhibitor herbicide is selected from one or more of below listed herbicides or their salts, esters, isomers, and combinations thereof as disclosed in Table 2.

TABLE 2
Acetyl CoA Carboxylase Inhibitor Herbicides

| | Chemical Class of Acetyl COA | Acetyl CoA carboxylase |
|---|---|---|
| Sr. No. | Carboxylase Inhibitor Herbicides | inhibitor herbicide |
| 1. | Aryloxyphenoxy-propionates | Clodinafop-propargyl |
| 2. | | Clofop |
| 3. | | Cyhalofop-butyl |
| 4. | | Diclofop-methyl |
| 5. | | Fenoxaprop-ethyl |
| 6. | | Fenthiaprop |
| 7. | | Fluazifop-butyl |
| 8. | | Haloxyfop-methyl |
| 9. | | Isoxapyrifop |
| 10. | | Metamifop |
| 11. | | Quizalofop-ethyl |
| 12. | | Quizalofop-p-tefuryl |
| 13. | Cyclohexanediones | Alloxydim |
| 14. | | Butroxydim |
| 15. | | Clethodim |
| 16. | | Cloproxydim |
| 17. | | Cycloxydim |
| 18. | | Profoxydim |
| 19. | | Sethoxydim |
| 20. | | Tepraloxydim |
| 21. | | Tralkoxydim |
| 22. | Phenylpyrazoline | Pinoxaden |

In an embodiment, acetolactate synthase inhibitor herbicide is selected from one or more of below listed herbicides or their salts, esters, isomers, and combinations thereof.

TABLE 3
Acetolactate Synthase Inhibitor Herbicides

| | Chemical Class of Acetolactate | Acetolactate synthase |
|---|---|---|
| Sr. No. | Synthase Inhibitor Herbicides | inhibitor herbicide |
| 1. | Imidazolinones | Imazamethabenz-methyl |
| 2. | | Imazamox |
| 3. | | Imazapic |
| 4. | | Imazapyr |
| 5. | | Imazaquin |
| 6. | | Imazamethabenz-methyl |
| 7. | Pyrimidinyl benzoates | Bispyribac-sodium |
| 8. | | Pyribenzoxim (prodrug of |
| | | bispyribac) |
| 9. | | Pyriftalid |
| 10. | | Pyriminobac-methyl |
| 11. | | Pyrithiobac-sodium |
| 12. | Sulfonanilides | Pyrimisulfan |
| 13. | | Triafamone |
| 14. | Sulfonylureas | Amidosulfuron |
| 15. | | Azimsulfuron |
| 16. | | Bensulfuron-methyl |
| 17. | | Chlorimuron-ethyl |
| 18. | | Chlorsulfuron |
| 19. | | Cinosulfuron |
| 20. | | Cyclosulfamuron |
| 21. | | Ethametsulfuron-methyl |
| 22. | | Ethoxysulfuron |
| 23. | | Flazasulfuron |
| 24. | | Flucetosulfuron |
| 25. | | Flupyrsulfuron-methyl-Na |
| 26. | | Foramsulfuron |
| 27. | | Imazosulfuron |
| 28. | | Iodosulfuron-methyl-Na |
| 29. | | Mesosulfuron-methyl |
| 30. | | Metazosulfuron |
| 31. | | Metsulfuron-methyl |
| 32. | | Nicosulfuron |
| 33. | | Orthosulfamuron |
| 34. | | Oxasulfuron |
| 35. | | Primisulfuron-methyl |
| 36. | | Propyrisulfuron |
| 37. | | Prosulfuron |
| 38. | | Pyrazosulfuron-ethyl |
| 39. | | Rimsulfuron |
| 40. | | Sulfometuron-methyl |
| 41. | | Sulfosulfuron |
| 42. | | Thifensulfuron-methyl |
| 43. | | Triasulfuron |
| 44. | | Tribenuron-methyl |
| 45. | | Trifloxysulfuron-Na |
| 46. | | Triflusulfuron-methyl |
| 47. | | Tritosulfuron |
| 48. | Triazolinones | Flucarbazone-Na |
| 49. | | Propoxycarbazone-Na |
| 50. | | Thiencarbazone-methyl |
| 51. | Triazolopyrimidine - Type 1 | Cloransulam-methyl |
| 52. | | Diclosulam |
| 53. | | Florasulam |
| 54. | | Flumetsulam |
| 55. | | Metosulam |
| 56. | Triazolopyrimidine - Type 2 | Penoxsulam |
| 57. | | Pyroxsulam |

In another embodiment, the present invention provides combinations of herbicides with one or more safeners wherein the combination of herbicides comprises at least one herbicide listed in Table 1, at least one herbicide listed in Table 2, at least one herbicide listed in Table 3, and a safener, wherein the combination of herbicides with one or more safeners exhibits less or no phytotoxicity in comparison to a combination without the safener.

In another embodiment, the present invention provides a herbicidal combination comprising:
(a) at least one photosystem II Inhibitor herbicide selected from the group comprising propanil, desmedipham, phenisopham, phenmedipham, atrazine, hexazinone, metamitron, metribuzin, amicarbazone, or combinations thereof;
(b) at least one acetyl COA carboxylase inhibitor herbicide selected from the group comprising clodinafop-propargyl, fenoxaprop-ethyl, fluazifop-butyl, haloxyfop-methyl, quizalofop-ethyl and quizalofop-p-tefuryl, clethodim, sethoxydim, pinoxaden, or combinations thereof;
(c) at least one acetolactate synthase inhibitor herbicide selected from of the group comprising imazamox, imazapic, imazapyr, bispyribac-sodium, bensulfuron-methyl, chlorimuron-ethyl, chlorsulfuron, metsulfuron-methyl, nicosulfuron, flucarbazone-Na, propoxycarbazone-Na, thiencarbazone-methyl, penoxsulam, or combinations thereof; and
(d) at least one safener selected from the group comprising mefenpyr-diethyl, isoxadifen-ethyl, cloquintocet-mexyl, dichlormid, benoxacor, flurazole fluxofenim, or combinations thereof.

In another embodiment, the present invention provides combinations of herbicides with one or more safeners wherein the combination of herbicides comprises:
(a) at least one photosystem II inhibitor herbicide comprising propanil;
(b) at least one acetyl COA carboxylase inhibitor herbicide selected from of the group comprising clodinafop-propargyl, fenoxaprop-ethyl, fluazifop-butyl, haloxyfop-methyl, quizalofop-ethyl and quizalofop-p-tefuryl, clethodim, sethoxydim, pinoxaden, or combinations thereof;
(c) at least one acetolactate synthase inhibitor herbicide selected the group comprising imazamox, imazapic, imazapyr, bispyribac-sodium, bensulfuron-methyl, chlorimuron-ethyl, chlorsulfuron, metsulfuron-methyl, nicosulfuron, flucarbazone-Na, propoxycarbazone-NA, thiencarbazone-methyl, penoxsulam, or combinations thereof, and
(d) at least one safener selected from the group comprising mefenpyr-diethyl, isoxadifen-ethyl, cloquintocet-mexyl, dichlormid, benoxacor, flurazole, fluxofenim, or combinations thereof.

In another embodiment, the present invention provides combinations of herbicides with one or more safeners wherein the combination of herbicides comprises:
(a) at least one photosystem II inhibitor herbicide selected from the group comprising propanil, desmedipham, phenisopham, phenmedipham, atrazine, hexazinone, metamitron, metribuzin, amicarbazone, or combinations thereof;
(b) at least one acetyl COA carboxylase inhibitor herbicide comprising clethodim;
(c) at least one acetolactate synthase inhibitor herbicide selected the group comprising imazamox, imazapic, imazapyr, bispyribac-sodium, bensulfuron-methyl, chlorimuron-ethyl, chlorsulfuron, metsulfuron-methyl, nicosulfuron, flucarbazone-Na, propoxycarbazone-NA, thiencarbazone-methyl, penoxsulam, or combinations thereof; and
(d) at least one safener selected from the group comprising mefenpyr-diethyl, isoxadifen-ethyl, cloquintocet-mexyl, dichlormid, benoxacor, flurazole, fluxofenim, or combinations thereof.

In another embodiment, the present invention provides combinations of herbicides with one or more safeners wherein the combination of herbicides comprises:
(a) at least one photosystem II inhibitor herbicide selected from the group comprising propanil, desmedipham, phenisopham, phenmedipham, atrazine, hexazinone, metamitron, metribuzin, amicarbazone, or combinations thereof;
(b) at least one acetyl COA carboxylase inhibitor herbicide comprising quizalofop-ethyl;
(c) at least one acetolactate synthase inhibitor herbicide selected the group comprising imazamox, imazapic, imazapyr, bispyribac-sodium, bensulfuron-methyl, chlorimuron-ethyl, chlorsulfuron, metsulfuron-methyl, nicosulfuron, flucarbazone-Na, propoxycarbazone-NA, thiencarbazone-methyl, penoxsulam, or combinations thereof; and
(d) at least one safener selected from the group comprising mefenpyr-diethyl, isoxadifen-ethyl, cloquintocet-mexyl, dichlormid, benoxacor, flurazole, fluxofenim, or combinations thereof.

In another embodiment, the present invention provides combinations of herbicides with one or more safeners wherein the combination of herbicides comprises:
(a) at least one photosystem II inhibitor herbicide selected from the group comprising propanil, desmedipham, phenisopham, phenmedipham, atrazine, hexazinone, metamitron, metribuzin, amicarbazone, or combinations thereof;
(b) at least one acetyl COA carboxylase inhibitor herbicide comprising haloxyfop-methyl;
(c) at least one acetolactate synthase inhibitor herbicide selected the group comprising imazamox, imazapic, imazapyr, bispyribac-sodium, bensulfuron-methyl, chlorimuron-ethyl, chlorsulfuron, metsulfuron-methyl, nicosulfuron, flucarbazone-Na, propoxycarbazone-NA, thiencarbazone-methyl, penoxsulam, or combinations thereof; and
(d) at least one safener selected from the group comprising mefenpyr-diethyl, isoxadifen-ethyl, cloquintocet-mexyl, dichlormid, benoxacor, flurazole, fluxofenim, or combinations thereof.

In another embodiment, the present invention provides combinations of herbicides with one or more safeners wherein the combination of herbicides comprises:
(a) at least one photosystem II Inhibitor herbicide comprising propanil;
(b) at least one acetyl COA carboxylase inhibitor herbicide selected from one or more of Clodinafop-propargyl, Fenoxaprop-ethyl, Fluazifop-butyl, Haloxyfop-methyl, Quizalofop-ethyl and Quizalofop-p-tefuryl, Clethodim, Sethoxydim and Pinoxaden;
(c) at least one acetolactate synthase inhibitor herbicide selected from the group comprising imazamox, imazapic, imazapyr, or combinations thereof; and
(d) at least one safener selected from the group comprising mefenpyr-diethyl, isoxadifen-ethyl, cloquintocet-mexyl, dichlormid, benoxacor, flurazole, fluxofenim, or combinations thereof.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener selected from the group comprising mefenpyr-diethyl, isoxadifen-ethyl, cloquintocet-mexyl, dichlormid, benoxacor, flurazole, fluxofenim, or combinations thereof.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener comprising mefenpyr-diethyl.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener comprising isoxadifen-ethyl.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener comprising cloquintocet-mexyl.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener comprising Dichlormid.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener comprising Benoxacor.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener comprising Flurazole.

In another embodiment, the present invention provides combinations of herbicides with one or more safeners wherein the combination of herbicides comprises:
(a) at least one photosystem II Inhibitor herbicide selected from propanil, metribuzin, or combinations thereof;
(b) at least one acetyl COA carboxylase inhibitor herbicide selected from one or more of Clodinafop-propargyl, Haloxyfop-methyl, Quizalofop-ethyl and Quizalofop-p-tefuryl, and Clethodim;
(c) at least one acetolactate synthase inhibitor herbicide selected from the group comprising imazamox, imazapic, imazapyr, or combinations thereof; and
(d) at least one safener comprising Fluxofenim.

In an embodiment the present combinations of herbicides with one or more safeners The target crops include, but not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, Zelkova, Japanese arborvitae, fir wood, hemlock, juniper, Pinus, Picea, and Taxus cuspidate, etc.

In still another embodiment, present invention provides combinations of herbicides with one or more safeners wherein herbicides comprise a combination of Acetyl CoA carboxylase inhibitor herbicides, Acetolactate synthase inhibitor herbicides, and Photosynthesis II inhibitor herbicides and said combinations are applied preferably to corn, wheat, barley, rye, oats, rice, soybean, cotton, canola, sugar beet, potatoes, tobacco, and oilseed rape directly or to soil in which their seeds are sown.

In still another embodiment, present invention provides combinations of herbicides comprising a combination of Acetyl COA carboxylase inhibitor herbicides, Acetolactate synthase inhibitor herbicides, and Photosynthesis II inhibitor herbicides with one or more safeners selected from Mefenpyr-diethyl, Isoxadifen-ethyl, Cloquintocet-mexyl, Dichlormid, Benoxacor, Flurazole and Fluxofenim and said combinations are applied preferably to corn, wheat, barley, rye, oats, rice, soybean, cotton, canola, sugar beet, potatoes, tobacco, and oilseed rape directly or to soil in which their seeds are sown.

In still another embodiment, present invention provides combinations of herbicides comprising a combination of Clodinafop-Propargyl, Cloquintocet-mexyl, and Flucarbazone with one or more safeners selected from Mefenpyr-diethyl, Isoxadifen-ethyl, Cloquintocet-mexyl, Dichlormid, Benoxacor, Flurazole and Fluxofenim and said combinations are applied preferably to corn, wheat, barley, rye, oats, rice, soybean, cotton, canola, sugar beet, potatoes, tobacco, and oilseed rape directly or to soil in which their seeds are sown.

In still another embodiment, present invention provides combinations of herbicides comprising a combination of Acetyl COA carboxylase inhibitor herbicides, Acetolactate synthase inhibitor herbicides, and Photosynthesis II inhibitor herbicides with one or more safeners selected from Mefenpyr-diethyl, Isoxadifen-ethyl, Cloquintocet-mexyl, Dichlormid, Benoxacor, Flurazole and Fluxofenim and said combinations exhibit less or no phytotoxicity, result in selective control, preferably in corn, wheat, barley, rye, oats, rice, soybean, cotton, canola, sugar beet, potatoes, tobacco, and oilseed rape.

In still another embodiment, present invention provides combinations of herbicides comprising a combination of Clodinafop-Propargyl, Cloquintocet-mexyl, and

Flucarbazone with one or more safeners selected from Mefenpyr-diethyl, Isoxadifen-ethyl, Cloquintocet-mexyl, Dichlormid, Benoxacor, Flurazole and Fluxofenim and said combinations exhibit less or no phytotoxicity, result in selective control, preferably in corn, wheat, barley, rye, oats, rice, soybean, cotton, canola, sugar beet, potatoes, tobacco, and oilseed rape.

In still another embodiment, present invention provides combinations of herbicides comprising a combination of Acetyl COA carboxylase inhibitor herbicides, Acetolactate synthase inhibitor herbicides, and Photosynthesis II inhibitor herbicides with one or more safeners selected from Mefenpyr-diethyl, Isoxadifen-ethyl, Cloquintocet-mexyl, Dichlormid, Benoxacor, Flurazole and Fluxofenim, wherein the combinations are applied preferably to corn, wheat, barley, rye, oats, rice, soybean, cotton, canola, sugar beet, potatoes, tobacco, and oilseed rape simultaneously or sequentially.

In still another embodiment, present invention provides combinations of herbicides comprising a combination of Clodinafop-Propargyl, Cloquintocet-mexyl, and Flucarbazone with one or more safeners selected from Mefenpyr-diethyl, Isoxadifen-ethyl, Cloquintocet-mexyl, Dichlormid, Benoxacor, Flurazole and Fluxofenim, wherein the combinations are applied preferably to corn, wheat, barley, rye, oats, rice, soybean, cotton, canola, sugar beet, potatoes, tobacco, and oilseed rape simultaneously or sequentially.

The combinations of one or more herbicide with one or more safeners according to the instant disclosure can be applied to the plants, seed of the plants and/or to the locus where the crop and weed plants are growing area under cultivation. The herbicides and safeners of said combinations can be applied simultaneously or in sequential order in both pre- as well as post-emergence application.

In another embodiment, the combination of the present invention is used to control weeds in various agricultural crops. Non-limiting examples of weeds controlled by the combination of the present invention include: Brassicaceae weeds: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, Coronopus didymus, and combinations thereof.

In another embodiment, the combination of the present invention is used to control weeds in various agricultural crops. Non-limiting examples of weeds controlled by the combination of the present invention include: Poaceae weeds: Dinebra retroflexa, Cynodon dactylon, Echinochloa colonum, Echinochloa crusgalli, Setaria viridis, Setaria faberi, Setaria glauca, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spicaventi, Panicum dichotomiflorum, Panicum texanum, Panicum maximum, Brachiaria reptains Brachiaria platyphylla, Brachiaria ruziziensis, Brachiaria plantaginea, Brachiaria decumbens, Brachiaria brizantha, Brachiaria humidicola, Brachiaria mutica, Cenchrus echinatus, Cenchrus pauciflorus, Eriochloa villosa, Pennisetum setosum, Chloris gayana, Chloris barbata, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis, and combinations thereof.

In still another embodiment, the herbicide safener combination is formulated together and applied in pre-emergence application or post-emergence application.

In still another embodiment, the herbicide safener combination is formulated together in oil dispersion (OD) or water dispersible granule (WG) formulation.

In still another embodiment, the herbicide safener combination is formulated together in oil dispersion (OD) formulation.

In still another embodiment, the herbicide safener combination is formulated together in water dispersible granules (WG) formulation.

In still another embodiment, the components are formulated separately and applied sequentially.

In still another embodiment, the safener is applied to the seeds or other propagation material of the crops prior to sowing or to the soil shortly after sowing in an in furrow-treatment.

In still another embodiment, the combination of herbicides comprising a combination of Acetyl COA carboxylase inhibitor herbicides, Acetolactate synthase inhibitor herbicides, and Photosynthesis II inhibitor herbicides and one or more safeners selected from Mefenpyr-diethyl, Isoxadifen-ethyl, Cloquintocet-mexyl, Dichlormid, Benoxacor, Flurazole and Fluxofenim is formulated together and applied in pre-emergence application or post-emergence application to preferably to corn, wheat, barley, rye, oats, rice, soybean, cotton, canola, sugar beet, potatoes, tobacco, and oilseed rape, more preferably to soybean directly or soil in which their seeds are sown.

In still another embodiment, the present invention provides a combination comprising Acetyl COA carboxylase inhibitor herbicides, Acetolactate synthase inhibitor herbicides, and Photosynthesis II inhibitor herbicides and one or more safeners selected from Mefenpyr-diethyl, Isoxadifen-ethyl, Cloquintocet-mexyl, Dichlormid, Benoxacor, Flurazole and Fluxofenim of the herbicide safener combination are formulated separately and applied sequentially preferably to corn, wheat, barley, rye, oats, rice, soybean, cotton, canola, sugar beet, potatoes, tobacco, and oilseed rape, more preferably to soybean directly or soil in which their seeds are sown.

In still another embodiment, the safener selected from Mefenpyr-diethyl, Isoxadifen-ethyl, Cloquintocet-mexyl, Dichlormid, Benoxacor, Flurazole and Fluxofenim is applied to the seeds or other propagation material of the crops prior to sowing or to the soil shortly after sowing in an in furrow-treatment.

In still another embodiment, the combination of herbicides comprising a combination of Acetyl COA carboxylase inhibitor herbicides, Acetolactate synthase inhibitor herbicides, and Photosynthesis II inhibitor herbicides and Cloquintocet-mexyl is formulated together and applied in pre-emergence application or post-emergence application preferably to corn, wheat, barley, rye, oats, rice, soybean, cotton, canola, sugar beet, potatoes, tobacco, and oilseed rape directly or to soil in which their seeds are sown, wherein Cloquintocet-mexyl is applied at the rate in the range from about 0.1 to 100 g a.i./ha.

In still another embodiment, the combination of herbicides comprising a combination of Acetyl COA carboxylase inhibitor herbicides, Acetolactate synthase inhibitor herbicides, and Photosynthesis II inhibitor herbicides and Cloquintocet-mexyl is formulated together and applied in pre-emergence application or post-emergence application preferably to corn, wheat, barley, rye, oats, rice, soybean, cotton, canola, sugar beet, potatoes, tobacco, and oilseed rape directly or to soil in which their seeds are sown, wherein Cloquintocet-mexyl is applied at the rate of 10.1 g a.i./ha.

In still another embodiment, the combination of herbicides comprising a combination of Clodinafop-Propargyl, Cloquintocet-mexyl, and Flucarbazone and Cloquintocet-mexyl is formulated together and applied in pre-emergence application or post-emergence application preferably to corn, wheat, barley, rye, oats, rice, soybean, cotton, canola, sugar beet, potatoes, tobacco, and oilseed rape directly or to soil in which their seeds are sown, wherein Cloquintocet-mexyl is applied at the rate of 10.1 g a.i./ha.

In an embodiment, the present invention provides a herbicidal composition comprising:
at least one Acetyl COA carboxylase inhibitor herbicides;
at least one Acetolactate synthase inhibitor herbicide;
at least one Photosynthesis II inhibitor herbicide;
at least one safener; and
at least one agrochemically acceptable excipient.

According to an embodiment of the present disclosure, the agrochemically acceptable excipients are selected from one or more of emulsifiers, colorants, thickeners/binders, antifreeze agents, biocides, antifoaming agents, antioxidants, solvents, preservatives, glidants, anticaking agents, pH-regulating agents, preservatives, buffering agents, formulation aids, disintegrants, and combinations thereof.

In another embodiment, emulsifiers which can be advantageously employed herein can be readily determined by those skilled in the art and include various non-ionic, anionic, cationic, and amphoteric emulsifiers, or a blend of two or more emulsifiers. Examples of non-ionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

In an embodiment, thickener or binder may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from polydimethoxysiloxane, polydimethylsiloxane, alkyl poly acrylates, castor oil, fatty acids, fatty acids esters, fatty acids sulfate, fatty alcohol, fatty alcohol esters, fatty alcohol sulfate, foot olive oil, mono & di glyceride, paraffin oil, paraffin wax, poly propylene glycol, silicones oil, vegetable fats, vegetable fats sulfate, vegetable oil, vegetable oil sulfate, vegetable wax, vegetable wax sulfate, agents based on silicon or magnesium stearate.

The agrochemical composition may also comprise one or more antioxidants. Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA, EGTA, phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to the invention, suitable derivatives (salts, esters, sugars, nucleotides, nucleosides, peptides, and lipids) and mixtures of these specified active ingredients or plant extracts (e.g., teatree oil, rosemary extract and rosemarinic acid) which comprise these antioxidants can be used. In general, mixtures of the aforementioned antioxidants are possible.

According to an embodiment, examples of suitable solvents are water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

In another embodiment, suitable preservatives are for example 1,2-benzisothiazolin-3-one and/or 2-Methyl-2H-isothiazol-3-one or sodium benzoate or benzoic acid.

In an embodiment, the present invention provides a herbicidal composition comprising:
clodinafop-propargyl;
cloquintocet-mexyl;
flucarbazone;
metribuzin; and
at least one agrochemically acceptable excipient.

In an embodiment, the present invention provides use of a herbicidal combination for selective control of weeds by applying the combination comprising clodinafop-propargyl, cloquintocet-mexyl, flucarbazone and metribuzin.

In an embodiment, the present invention provides a method for selective control of weeds by applying a herbicidal combination comprising clodinafop-propargyl, cloquintocet-mexyl, flucarbazone and metribuzin.

In an embodiment, the present invention provides a method for selective control of weeds by applying a herbicidal composition comprising one or more Acetyl COA carboxylase inhibitor herbicide, one or more Acetolactate synthase inhibitor herbicide, one or more Photosynthesis II inhibitor herbicide, one or more safener along with an agrochemically acceptable excipient.

In an embodiment, the present invention provides a method for selective control of weeds by applying a herbicidal composition comprising clodinafop-propargyl, cloquintocet-mexyl, flucarbazone and metribuzin along with an agrochemically acceptable excipient.

In an embodiment, the present invention provides a method for selective control of weeds by applying a herbicidal combination comprising clodinafop-propargyl, cloquintocet-mexyl, flucarbazone and metribuzin, wherein the herbicidal combination is in a form of an oil dispersion (OD).

In an embodiment, the present invention provides a method for selective control of weeds by applying a herbicidal combination comprising clodinafop-propargyl, cloquintocet-mexyl, flucarbazone and metribuzin in an OD formulation, wherein clodinafop-propargyl is applied at a rate from about 10 to about 300 g a.i./ha. In an embodiment, clodinafop-propargyl is applied at a rate from about 10 to about 250 g a.i./ha. In an embodiment, clodinafop-propargyl is applied at a rate from about 10 to about 200 g a.i./ha. In an embodiment, clodinafop-propargyl is applied at a rate from about 10 to about 150 g a.i./ha. In an embodiment, clodinafop-propargyl is applied at a rate from about 10 to about 100 g a.i./ha.

In an embodiment, the present invention provides a method for selective control of weeds by applying a herbicidal combination comprising clodinafop-propargyl, cloquintocet-mexyl, flucarbazone and metribuzin in an OD formulation, wherein clodinafop-propargyl is applied at a rate of about 50 g a.i./ha.

In an embodiment, the present invention provides a method for selective control of weeds by applying a herbicidal combination comprising clodinafop-propargyl, cloquintocet-mexyl, flucarbazone and metribuzin in an OD formulation, wherein cloquintocet-mexyl is applied at a rate from about 0.1 to about 200 g a.i./ha. In an embodiment, cloquintocet-mexyl is applied at a rate from about 0.1 to about 150 g a.i./ha. In an embodiment, cloquintocet-mexyl is applied at a rate from about 0.1 to about 100 g a.i./ha. In an embodiment, cloquintocet-mexyl is applied at a rate from about 0.1 to about 75 g a.i./ha. In an embodiment, cloquintocet-mexyl is applied at a rate from about 0.1 to about 50 g a.i./ha. In an embodiment, cloquintocet-mexyl is applied at a rate from about 10 to about 50 g a.i./ha.

In an embodiment, the present invention provides a method for selective control of weeds by applying a herbicidal combination comprising clodinafop-propargyl, cloquintocet-mexyl, flucarbazone and metribuzin in an OD formulation, wherein cloquintocet-mexyl is applied at a rate of about 14.5 g a.i./ha.

In an embodiment, the present invention provides a method for selective control of weeds by applying a herbicidal combination comprising clodinafop-propargyl, cloquintocet-mexyl, flucarbazone and metribuzin in an OD formulation, wherein flucarbazone is applied at a rate from about 10 to about 200 g a.i./ha. In an embodiment, flucarbazone is applied at a rate from about 10 to about 190 g a.i./ha. In an embodiment, flucarbazone is applied at a rate from about 50 to about 190 g a.i./ha. In an embodiment, flucarbazone is applied at a rate from about 70 to about 190 g a.i./ha. In an embodiment, flucarbazone is applied at a rate from about 100 to about 190 g a.i./ha.

In an embodiment, the present invention provides a method for selective control of weeds by applying a herbicidal combination comprising clodinafop-propargyl, cloquintocet-mexyl, flucarbazone and metribuzin in an OD formulation, wherein flucarbazone is applied at a rate of about 170 g a.i./ha.

In an embodiment, the present invention provides a method for selective control of weeds by applying a herbicidal combination comprising clodinafop-propargyl, cloquintocet-mexyl, flucarbazone and metribuzin in an OD formulation, wherein metribuzin is applied at a rate from about 10 to about 200 g a.i./ha. In an embodiment, metribuzin is applied at a rate from about 10 to about 190 g a.i./ha. In an embodiment, metribuzin is applied at a rate from about 10 to about 150 g a.i./ha. In an embodiment, metribuzin is applied at a rate from about 10 to about 100 g a.i./ha.

In an embodiment, the present invention provides a method for selective control of weeds by applying a herbicidal combination comprising clodinafop-propargyl, cloquintocet-mexyl, flucarbazone and metribuzin in an OD formulation, wherein metribuzin is applied at a rate of 70 g a.i./ha.

In an embodiment, the present invention provides a method for selective control of weeds by applying a herbicidal combination comprising clodinafop-propargyl, cloquintocet-mexyl, flucarbazone and metribuzin, wherein the herbicidal combination is in a form of a water dispersible granule (WG or WDG).

In an embodiment, the present invention provides a method for selective control of weeds by applying a herbicidal combination comprising clodinafop-propargyl, cloquintocet-mexyl, flucarbazone and metribuzin in a WG formulation, wherein clodinafop-propargyl is applied at a rate from about 50 to about 200 g a.i./ha. In an embodiment, clodinafop-propargyl is applied at a rate from about 50 to about 150 g a.i./ha. In an embodiment, clodinafop-propargyl is applied at a rate from about 70 to about 150 g a.i./ha. In an embodiment, clodinafop-propargyl is applied at a rate from about 70 to about 130 g a.i./ha.

In an embodiment, the present invention provides a method for selective control of weeds by applying a herbicidal combination comprising clodinafop-propargyl, cloquintocet-mexyl, flucarbazone and metribuzin in a WG formulation, wherein clodinafop-propargyl is applied at a rate of about 100 g a.i./ha.

In an embodiment, the present invention provides a method for selective control of weeds by applying a herbicidal combination comprising clodinafop-propargyl, cloquintocet-mexyl, flucarbazone and metribuzin in a WG formulation, wherein cloquintocet-mexyl is applied at a rate from about 0.1 to about 100 g a.i./ha. In an embodiment, cloquintocet-mexyl is applied at a rate from about 0.1 to about 90 g a.i./ha. In an embodiment, cloquintocet-mexyl is applied at a rate from about 0.1 to about 80 g a.i./ha. In an embodiment, cloquintocet-mexyl is applied at a rate from about 0.1 to about 75 g a.i./ha. In an embodiment, cloquintocet-mexyl is applied at a rate from about 0.1 to about 50 g a.i./ha. In an embodiment, cloquintocet-mexyl is applied at a rate from about 10 to about 50 g a.i./ha.

In an embodiment, the present invention provides a method for selective control of weeds by applying a herbicidal combination comprising clodinafop-propargyl, cloquintocet-mexyl, flucarbazone and metribuzin in a WG formulation, wherein cloquintocet-mexyl is applied at a rate of about 29 g a.i./ha.

In an embodiment, the present invention provides a method for selective control of weeds by applying a herbicidal combination comprising clodinafop-propargyl, cloquintocet-mexyl, flucarbazone and metribuzin in a WG formulation, wherein flucarbazone is applied at a rate from about 10 to about 200 g a.i./ha. In an embodiment, flucarbazone is applied at a rate from about 10 to about 190 g a.i./ha. In an embodiment, flucarbazone is applied at a rate from about 50 to about 190 g a.i./ha. In an embodiment, flucarbazone is applied at a rate from about 70 to about 190 g a.i./ha. In an embodiment, flucarbazone is applied at a rate from about 100 to about 190 g a.i./ha.

In an embodiment, the present invention provides a method for selective control of weeds by applying a herbicidal combination comprising clodinafop-propargyl, cloquintocet-mexyl, flucarbazone and metribuzin in a WG formulation, wherein flucarbazone is applied at a rate of about 140 g a.i./ha.

In an embodiment, the present invention provides a method for selective control of weeds by applying a herbicidal combination comprising clodinafop-propargyl, cloquintocet-mexyl, flucarbazone and metribuzin in a WG formulation, wherein metribuzin is applied at a rate from about 100 to about 400 g a.i./ha. In an embodiment, metribuzin is applied at a rate from about 150 to about 390 g a.i./ha. In an embodiment, metribuzin is applied at a rate from about 200 to about 380 g a.i./ha. In an embodiment, metribuzin is applied at a rate from about 300 to about 370 g a.i./ha.

In an embodiment, the present invention provides a method for selective control of weeds by applying a herbicidal combination comprising clodinafop-propargyl, cloquintocet-mexyl, flucarbazone and metribuzin in a WG formulation, wherein metribuzin is applied at a rate of about 340 g a.i./ha.

In an embodiment, the present invention provides a method for selective control of weeds by applying a herbicidal combination comprising:
one or more Acetyl COA carboxylase inhibitor herbicide applied at a rate from about 10 to about 100 g a.i./ha;
one or more Acetolactate synthase inhibitor herbicide applied at a rate from about 100 to about 200 g a.i./ha;
one or more Photosynthesis II inhibitor herbicide applied at a rate from about 10 to about 100 g a.i./ha; and
one or more safener applied at a rate from about 0.1 to about 50 g a.i./ha.

In an embodiment, the present invention provides a method for selective control of weeds by applying a herbicidal combination comprising:
one or more Acetyl COA carboxylase inhibitor herbicide applied at a rate from about 50 to about 200 g a.i./ha;
one or more Acetolactate synthase inhibitor herbicide applied at a rate from about 100 to about 200 g a.i./ha;
one or more Photosynthesis II inhibitor herbicide applied at a rate from about 200 to about 400 g a.i./ha; and
one or more safener applied at a rate from about 0.1 to about 100 g a.i./ha.

In an embodiment, the present invention provides a method for selective control of weeds by applying a herbicidal combination in an OD formulation, the combination comprising:
clodinafop-propargyl applied at a rate from about 10 to about 100 g a.i./ha;
cloquintocet-mexyl applied at a rate from about 0.1 to about 50 g a.i./ha;
flucarbazone applied at a rate from about 100 to about 200 g a.i./ha; and
metribuzin applied at a rate from about 10 to about 100 g a.i./ha.

In an embodiment, the present invention provides a method for selective control of weeds by applying a herbicidal combination in an OD formulation, the combination comprising:
clodinafop-propargyl applied at a rate of about 50 g a.i./ha;
cloquintocet-mexyl applied at a rate of about 14.5 g a.i./ha;
flucarbazone applied at a rate of about 170 g a.i./ha; and
metribuzin applied at a rate of about 70 g a.i./ha.

In an embodiment, the present invention provides a method for selective control of weeds by applying a herbicidal combination in a WDG formulation, the combination comprising:
clodinafop-propargyl applied at a rate from about 50 to about 200 g a.i./ha;
cloquintocet-mexyl applied at a rate from about 10 to about 100 g a.i./ha;
flucarbazone applied at a rate from about 100 to about 200 g a.i./ha; and
metribuzin applied at a rate from about 200 to 400 g a.i./ha.

In an embodiment, the present invention provides a method for selective control of weeds by applying a herbicidal combination in a WDG formulation, the combination comprising:
clodinafop-propargyl applied at a rate of about 100 g a.i./ha,
cloquintocet-mexyl applied at a rate of about 29 g a.i./ha,
flucarbazone applied at a rate of about 140 g a.i./ha and
metribuzin applied at a rate of about 340 g a.i./ha.

In another embodiment, the herbicidal combination is applied jointly, or separately, or sequentially, or simultaneously to a plant or locus thereof to control from about 50% to about 100% of the weeds.

In another embodiment, the herbicidal combination is applied jointly, or separately, or sequentially, or simultaneously to a plant or locus thereof to control from about 60% to about 100% of the weeds.

The herbicide safener combination/compositions of the present invention can reduce phytotoxicity of herbicides comprising a combination of one or more Acetyl CoA carboxylase inhibitor herbicides, Acetolactate synthase inhibitor herbicides, and Photosynthesis II inhibitor herbicides and therefore provide selective control of weeds.

In another embodiment, the present invention provides a kit of parts comprising a combination of one or more Acetyl COA carboxylase inhibitor herbicides, one or more Acetolactate synthase inhibitor herbicides, one or more Photosynthesis II inhibitor herbicides along with one or more safener; wherein the components are mixed together at the time of use to yield a composition for selective control of weeds.

In another embodiment, the present invention provides a kit of parts comprising a combination of clodinafop-propargyl, cloquintocet-mexyl, flucarbazone and metribuzin; wherein the components are mixed together at the time of use to yield a composition for selective control of weeds.

In another embodiment, the aforementioned kit of parts may additionally comprise a third component of at least one agrochemically acceptable excipient selected from the group consisting of one or more of disintegrant, binder, glidant, anticaking agents, pH-regulating agents, preservatives, biocides, antifoaming agents, colorants, buffering agents, formulation aids, and combinations thereof.

According to an embodiment, the kit of parts comprises:
at least one Acetyl COA carboxylase inhibitor herbicide;
at least one Acetolactate synthase inhibitor herbicides;
at least one Photosynthesis II inhibitor herbicides; and
at least one safener;
and optionally further comprises:
instructions for use.

The kit-of-parts may be accompanied by a set of instructions in form of a manual, guide, booklet, pamphlet, and so forth.

As will be demonstrated in the examples, the combinations of one or more herbicides with one or more safeners exhibited selective control.

These and other advantages of the invention may become more apparent from the examples set forth herein below. These examples are provided merely as illustrations of the invention and are not intended to be construed as a limitation thereof.

### EXAMPLES

### Example 1: Bio-Efficacy Trials

Experiments were carried out to evaluate the selectivity of combinations of one or more Acetyl COA carboxylase inhibitor herbicides, Acetolactate synthase inhibitor herbicides, and Photosynthesis II inhibitor herbicides with safeners.

Table 4 gives summary of the formulation details and application details of Acetyl CoA carboxylase inhibitor herbicides, Acetolactate synthase inhibitor herbicides, Photosynthesis II inhibitor herbicides and Safeners use for the treatments on wheat in OD formulation. Application method was spray and applications were made to soil.

TABLE 4

| | | Dose of | |
|---|---|---|---|
| | | formulated | |
| | | product (Oil | |
| | | Dispersion) | Dose of actives |
| Sr. No. | Herbicides and safeners | (g a.i./ha) | (g a.i./ha) |
| 1 | Clodinafop-propargyl + | 500 | 50 + |
| | Cloquintocet-mexyl + | | 14.5 + |
| | Flucarbazone + | | 170 + |
| | Metribuzin | | 70 |

Table 5 gives summary of the formulation details and application details of Acetyl CoA carboxylase inhibitor herbicides, Acetolactate synthase inhibitor herbicides, Photosynthesis II inhibitor herbicides and Safeners use for the treatments on wheat in WG formulation. Application method was spray and applications were made to soil.

TABLE 5

| | | Dose of | |
|---|---|---|---|
| | | formulated | |
| | | product (Water | |
| | | dispersible | |
| | | granule) | Dose of actives |
| Sr. No. | Herbicides and safeners | (g a.i./ha) | (g a.i./ha) |
| 1 | Clodinafop-propargyl + | 500 | 100 + |
| | Cloquintocet-mexyl + | | 29 + |
| | Flucarbazone + | | 140 + |
| | Metribuzin | | 340 |

Below provided the efficacy (%) of post-emergence control of weeds in wheat.

TABLE 6

| | | | | Lolium | | | |
|---|---|---|---|---|---|---|---|
| | | | | multiflorum & | | Rapistrum | |
| | | Avena Fatua | | Lolium perenne | | spp. | |
| Sr. | Herbicides and | 30 | 60 | 30 | 60 | 30 | 60 |
| No. | safeners | DAS* | DAS* | DAS* | DAS* | DAS* | DAS* |
| 1 | Clodinafoppropargyl + | 91.7 | 90.0 | 81.25 | 83.75 | 100 | 89.75 |
| | Cloquintocetmexyl + | | | | | | |
| | Flucarbazone + | | | | | | |
| | Metribuzin | | | | | | |

DAS* = Days after spraying

It was observed that the combination showed good efficacy (%) control in Avena fatua spp., Lolium multiflorum spp. & Lolium perenne spp., and Rapistrum spp. in wheat.

Below provided the phytotoxicity scale by the European Weeds Research Society (EWRS) in post emergence of weeds in wheat.

TABLE 7

| Sr. No. | Herbicides and safeners | 30 DAS* | 0 DAS* |
|---|---|---|---|
| 1 | Clodinafop-propargyl + | 1 | 1 |
| | Cloquintocet-mexyl + | | |
| | Flucarbazone + Metribuzin | | |

DAS* = Days after spraying

It was observed that the combination showed good phytotoxicity on the phytotoxicity scale.

Below provided the percentage efficacy of post-emergence control of weeds in wheat crop.

TABLE 8

| | | CHEAL | | LITAR | | HISIN | | LCASE | |
|---|---|---|---|---|---|---|---|---|---|
| | | 15 | 45 | 30 | 60 | 15 | 45 | 15 | 45 |
| Sr. | Herbicides | DAS | DAS | DAS | DAS | DAS | DAS | DAS | DAS |
| No. | and safeners | * | * | * | * | * | * | * | * |
| 1 | Clodinafoppropargyl + | 93.5 | 100 | 92.5 | 100 | 80 | 100 | 98 | 87.4 |
| | Cloquintocetmexyl + | | | | | | | | |
| | Flucarbazone + | | | | | | | | |
| | Metribuzin | | | | | | | | |

DAS * = Days after spraying,
CHEAL = Chenopodium Album,
LITAR = Lithospermum Arvense
HISIN = Hirsfeldia Incana,
LCASE = Lactuca Serriola

It was observed that the combination showed good efficacy (%) control in post-emergence of weeds in wheat.

Below provided the phytotoxicity scale by the European Weeds Research Society (EWRS) in post emergence of cultivation and weeds in wheat.

TABLE 9

| Sr. | Herbicides | 7 | 15 | 30 | 45 | 60 | 75 |
|---|---|---|---|---|---|---|---|
| No. | and safeners | DAS* | DAS* | DAS* | DAS* | DAS* | DAS* |
| 1 | Clodinafoppropargyl + | 1 | 1 | 1 | 1 | 1 | 1 |
| | Cloquintocetmexyl + | | | | | | |
| | Flucarbazone + | | | | | | |
| | Metribuzin | | | | | | |

DAS* = Days after spraying

It was observed that the combination showed good phytotoxicity on the phytotoxicity scale.

### Example 2: Bio-Efficacy Trials

The trials were conducted to evaluate the efficacy for the present combination for controlling weeds-Lolium spp, and Brassica spp. in wheat crop. The treatments comprise applying a combination of herbicides, clodinafop-propargyl, Flucarbazone and Metribuzin along with the safener (cloquintocet-mexyl) to weeds. The results are displayed in Table 10.

TABLE 10

| | | | Dose | Lolium spp. | | Brassica spp. | |
|---|---|---|---|---|---|---|---|
| Sr. | | Formulation | (g | 21 | 28 | 21 | 28 |
| No. | Treatment | Type | a.i./ha) | DAA | DAA | DAA | DAA |
| 1 | Clodinafoppropargyl + | OD | 500 | 70.0 | 78.9 | 88.8 | 78.8 |
| | Flucarbazone + | | | | | | |
| | Metribuzin | | | | | | |
| 2 | Clodinafoppropargyl + | OD | 600 | 76.3 | 83.8 | 92.5 | 83.8 |
| | Flucarbazone + | | | | | | |
| | Metribuzin | | | | | | |
| 3 | Clodinafoppropargyl + | OD | 700 | 63.8 | 87.5 | 85.0 | 87.5 |
| | Flucarbazone + | | | | | | |
| | Metribuzin | | | | | | |
| 4 | Clodinafoppropargyl + | OD | 1200 | 88.8 | 93.8 | 95.8 | 93.8 |
| | Flucarbazone + | | | | | | |
| | Metribuzin | | | | | | |
| 5 | Clodinafoppropargyl + | WG | 500 | 66.3 | 87.5 | 88.7 | 87.5 |
| | Flucarbazone + | | | | | | |
| | Metribuzin | | | | | | |
| 6 | Clodinafoppropargyl + | WG | 600 | 72.5 | 87.5 | 91.3 | 87.5 |
| | Flucarbazone + | | | | | | |
| | Metribuzin | | | | | | |

*DAA—Days after application

It is evident from Table 10 that the herbicide combination along with safener shows efficacy in control of weeds in wheat.

### Example 3: Bio-Efficacy Trials

The trials were conducted to evaluate the efficacy for the present combination for controlling weeds-Avena Fatua spp., Rapistrum spp, and Poligonum spp. in wheat crop. The treatments comprise applying a combination of herbicides, Clodinafop-propargyl, Flucarbazone and Metribuzin along with the safener (cloquintocet-mexyl) to weeds. The results are displayed in Table 11.

TABLE 11

| | | | Dose | Avena Fatua | | Rapistrum | | Poligonum | |
|---|---|---|---|---|---|---|---|---|---|
| | | | (g | spp. | | spp. | | spp. | |
| Sr. | | Formulation | a.i./ | 21 | 28 | 21 | 28 | 21 | 28 |
| No. | Treatment | Type | ha) | DAA | DAA | DAA | DAA | DAA | DAA |
| 1 | Clodinafoppropargyl + | OD | 400 | 70.0 | 100 | 86.7 | 93.2 | 66.7 | 92.0 |
| | Flucarbazone + | | | | | | | | |
| | Metribuzin | | | | | | | | |
| 2 | Clodinafoppropargyl + | OD | 500 | 71.7 | 100 | 90.8 | 95.6 | 68.8 | 85.3 |
| | Flucarbazone + | | | | | | | | |
| | Metribuzin | | | | | | | | |
| 3 | Clodinafoppropargyl + | OD | 600 | 80.0 | 100 | 92.8 | 98.3 | 76.3 | 90.0 |
| | Flucarbazone + | | | | | | | | |
| | Metribuzin | | | | | | | | |
| 4 | Clodinafoppropargyl + | OD | 700 | 84.3 | 100 | 96.0 | 100 | 73.3 | 92.3 |
| | Flucarbazone + | | | | | | | | |
| | Metribuzin | | | | | | | | |
| 5 | Clodinafoppropargyl + | OD | 1200 | 86.3 | 100 | 97.7 | 100 | 85.0 | 100 |
| | Flucarbazone + | | | | | | | | |
| | Metribuzin | | | | | | | | |
| 6 | Clodinafoppropargyl + | WG | 500 | 85.0 | 93.6 | 94.0 | 100 | 72.5 | 71.1 |
| | Flucarbazone + | | | | | | | | |
| | Metribuzin | | | | | | | | |
| 7 | Clodinafoppropargyl + | WG | 600 | 81.7 | 98.3 | 98.0 | 100 | 79.3 | 99.3 |
| | Flucarbazone + | | | | | | | | |
| | Metribuzin | | | | | | | | |

*DAA—Days after application

It is evident from Table 11 that the herbicide combination along with safener shows efficacy in control of weeds in wheat.

1. A herbicidal combination comprising:
at least one acetyl COA carboxylase inhibitor herbicide;
at least one acetolactate synthase inhibitor herbicide;
at least one photosynthesis II inhibitor herbicide; and
at least one safener.

2. The combination as claimed in claim 1, wherein the acetyl COA carboxylase inhibitor herbicide is clodinafop-propargyl.

3. The combination as claimed in claim 1, wherein the acetolactate synthase inhibitor herbicide is flucarbazone.

4. The combination as claimed in claim 1, wherein the photosynthesis II inhibitor herbicide is metribuzin.

5. The combination as claimed in claim 1, wherein the safener is selected from the group consisting of cloquintocet-mexyl, mefenpyr-diethyl, isoxadifen-ethyl, dichlormid, benoxacor, flurazole, fluxofenim, and combinations thereof.

6. The combination as claimed in claim 1, wherein the acetyl COA carboxylase inhibitor herbicide is applied at a rate from about 10 to about 250 g a.i./ha.

7. The combination as claimed in claim 1, wherein the acetolactate synthase inhibitor herbicide is applied at a rate from about 10 to about 200 g a.i./ha.

8. The combination as claimed in claim 1, wherein the photosynthesis II inhibitor herbicide is applied at a rate from about 10 to about 200 g a.i./ha.

9. The combination as claimed in claim 1, wherein the safener is applied at a rate from about 0.1 to about 200 g a.i./ha.

10. The combination as claimed in claim 1, wherein the combination is present in a form of an oil dispersion or a water-dispersible granule formulation.

11. A method for controlling weeds by applying a herbicidal combination comprising:
at least one acetyl COA carboxylase inhibitor herbicide;
at least one acetolactate synthase inhibitor herbicide;
at least one photosynthesis II inhibitor herbicide; and
at least one safener.

12. The method as claimed in claim 10, wherein the combination is applied jointly, or separately, or sequentially, or simultaneously to a plant or locus thereof to control from about 60% to about 100% of the weeds.

13. (canceled)

14. A herbicidal composition comprising:
at least one acetyl COA carboxylase inhibitor herbicide;
at least one acetolactate synthase inhibitor herbicide;
at least one photosynthesis II inhibitor herbicide;
at least one safener; and
at least one agrochemically acceptable excipient.
